(19) United States
(12) Patent Application Publication
(10) Pub. No.: US 2009/0094552 A1
(43) Pub. Date: Apr. 9, 2009

(54) Guided Transition User Interfaces

(75) Inventors: Eric Watson, Redmond, WA (US); Krishna Sunkammurali, Sammamish, WA (US); Kenneth P. Coleman, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/867,008

(22) Filed: Oct. 4, 2007

(51) Int. Cl. G06F 3/048

(52) U.S. Cl. 715/804

(57) ABSTRACT

A guided transition user interface may be used to transition from a first user interface to a second user interface. The guided transition user interface may include a representation of the second user interface as well as a description of a task to perform from the first user interface. The guided transition user interface may include a graphical image of the second user interface with annotated or highlighted areas that are related to the task. The guided transition user interface may be used for transitioning between areas of one application, transitioning between applications, and transitioning between interacting with different computing devices.

### BACKGROUND

Many computing applications may have the capability of launching other computing applications. In many cases, a first computer application may have a different look and feel or user interface than a second application that may be launched from the first. In many cases, the visual transition from one application to another may be confusing or abrupt to a user.

Computer management systems are an example of applications that may call other applications. A management console may have links to various utility applications that may perform various computer management tasks. In some cases, such utility applications may have many options or capabilities that may be confusing when a user intends to perform a specific task within the utility application.

### SUMMARY

A guided transition user interface may be used to transition from a first user interface to a second user interface. The guided transition user interface may include a representation of the second user interface as well as a description of a task to perform from the first user interface. The guided transition user interface may include a graphical image of the second user interface with annotated or highlighted areas that are related to the task. The guided transition user interface may be used for transitioning between areas of one application, transitioning between applications, and transitioning between and interacting with different computing devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a user interface progression.

FIG. 2 is a diagram illustration of an embodiment showing a system with a guided transition user interface.

FIG. 3 is a flowchart illustration of an embodiment showing a method for guided transition user interfaces.

### DETAILED DESCRIPTION

Transitions between one user interface to another, especially when the interfaces may be from two different applications, can be bridged with a guided transition user interface that may provide a preview and instructions for performing a task or operating the second user interface. The guided transition user interface may include a thumbnail or other image of the second user interface and may also include highlighting to help direct a user's focus to a specific portion of the second user interface.

The guided transition user interface may be used for bridging a transition from one user interface to another, especially when the second user interface has a different look and feel or when the second user interface is complex and is being employed to perform a very specific task.

The guided transition user interface may be displayed quickly when a link to the second user interface is selected, and may bridge the time period when a second user interface is loaded and prepared for display. The guided transition user interface may serve as a splash screen by indicating to a user that a second user interface is being prepared.

When the guided transition user interface is initially displayed in a multi-window environment, the guided transition user interface may be displayed on top of other windows and may maintain the focus of the multi-window environment. In some embodiments, the second user interface may be displayed below the guided transition user interface and may be brought into focus after a time out period for the guided transition user interface or when a user dismisses the guided transition user interface.

The guided transition user interface may include a task description, help text, or other information in textual or graphical format. In some embodiments, various graphical representations of the second user interface may be presented with or without a textual description of a task to perform or other instructions.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

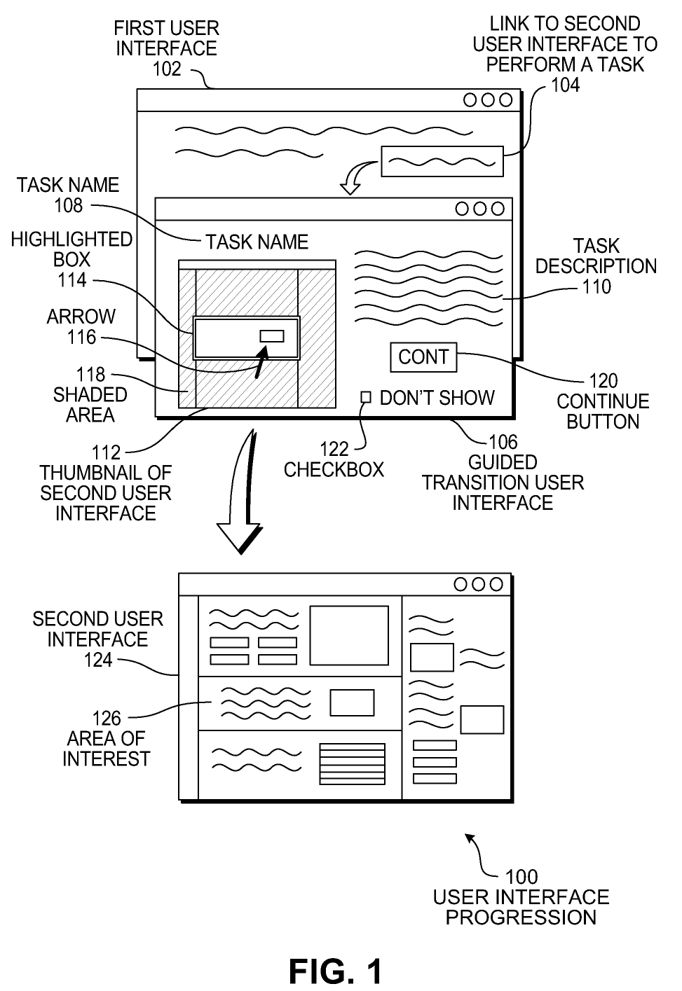

FIG. 1 is a diagram of an embodiment 100 showing a user interface progression using a guided transition user interface. Embodiment 100 illustrates one version of a sequence of user interfaces that may include a guided transition user interface. The guided transition user interface 106 may bridge the user experience from a first user interface 102 to a second user interface 124. In some cases, the first user interface 102 and second user interface 124 may be very different and may even be provided by different applications or systems. The user interfaces may have different fit and finishes, different user interface controls, or may offer vastly different user experiences.

The first user interface 102 may include a link 104 to a second user interface. In some cases, the link 104 may be to perform a specific task.

In an example, the first user interface 102 may be for a management console for a computer or server. The management console may perform many different monitoring tasks such as configuring network services or establishing a backup operation. Some tasks may modify various services managed by the console, but may use a separate user interface provided by an application or service interface. The management console may present the status of various components and services, but taking action on those services may use a different application with a different user interface.

In the example, a second user interface may be provided by a second application. The second user interface may be a complex user interface and may have many options and may also have a different look and feel from the management console. The management console may provide a link to call the second application and present the second application in a view that enables a user to perform a specific task. Because the task may be complex and have a lot of different functionality, a guided transition user interface may focus and guide a user from the management console to the second application to perform a specific task.

The guided transition user interface 106 may prepare a user for the experience of the second user interface 124 with a number of features. The task name 108 and task description 110 may provide a written description of the task to be performed and the steps a user may take. The task description 110 may include a step by step sequence of actions, and may be directly or indirectly related to the specific task indicated by the link 104.

The guided transition user interface 106 may include a graphical representation of the second user interface 124 that may us a thumbnail image 112 of the second user interface. The thumbnail image 112 may be modified by a highlighted box 114, an arrow 116, and shading 118 to draw a user's attention and focus to a specific area within the user interface. Other modifications may also be used on the image, including highlighting boxes, circles, highlighted areas, shaded areas, areas or items defined by different colors, highlighted text, shaded text, and other graphical devices that may draw a user's attention and prepare the user for interacting with the second user interface 124.

The highlights and thumbnail image 112 may be designed to draw a user's attention to an area of interest 126 within the second user interface 124. The second user interface 124 may be complex and have a lot of different features and functionality, but by annotating and highlighting the thumbnail image 112, a user may be better able to identify the specific area of interest 126 within the second user interface 124 and perform a desired task.

The guided transition user interface 106 may use any type of mechanism to guide a user during the transition to a second user interface 124. In some cases, an animated graphic or movie may show an action being performed. In other cases, audio clips may be played that explain an aspect of the second user interface 124 using spoken words or merely play a short sound to indicate that control is being shifted to a second user interface 124.

In some embodiments, the thumbnail image 112 may be created ahead of time, while in other embodiments the thumbnail image 112 may be created on the fly. In order to create a thumbnail image 112 on the fly, the second user interface 124 may be launched and a thumbnail image 112 generated based on the actual second user interface 124. In some embodiments where the second user interface 124 may take several seconds to be generated, a predefined image may be used so that the guided transition user interface 106 may be presented to the user during the time lag.

Once the guided transition user interface 106 is displayed, it may be handled in several different manners. In one embodiment, the guided transition user interface 106 may be displayed for a short period of time as the top window in a multi-window environment. The second user interface 124 may be created and displayed below the guided transition user interface 106, and after a short period of time, the guided transition user interface 106 may disappear and the second user interface 124 may be raised to the top window.

In another embodiment, the guided transition user interface 106 may be positioned as the top window in a multi-window environment and may remain in place until a user selects a continue button 120, after which the guided transition user interface 106 may be removed and the second user interface 124 may be made the active window.

In yet another embodiment, the guided transition user interface 106 may be able to remain as an active window so that the user may be able to refer to the guided transition user interface 106 while interacting with the second user interface 124.

In some embodiments, the guided transition user interface 106 may have a checkbox 122 that a user may engage so that a guided transition user interface 106 may not be displayed again for the particular task.

The guided transition user interface 106 may have several interactive features, such as buttons, scroll bars, selection mechanisms, and other user interface devices that may enable a user to gather additional information, such as more detailed instructions for the second user interface 124. The interactive features may enable a user to perform various control operations with the guided transition user interface 106, such as removing the interface, moving the interface, preventing the interface from being displayed in the future, and other control operations.

In some embodiments, the guided transition user interface 106 may have a link that may bring up a window with detailed instructions for how to perform a specific task or a help menu of some sort.

Some designs for a guided transition user interface 106 may be a smaller window or screen than that of the second user interface 124. In such designs, the guided transition user interface 106 may be presented while the second user interface 124 may be created and displayed behind the guided transition user interface 106.

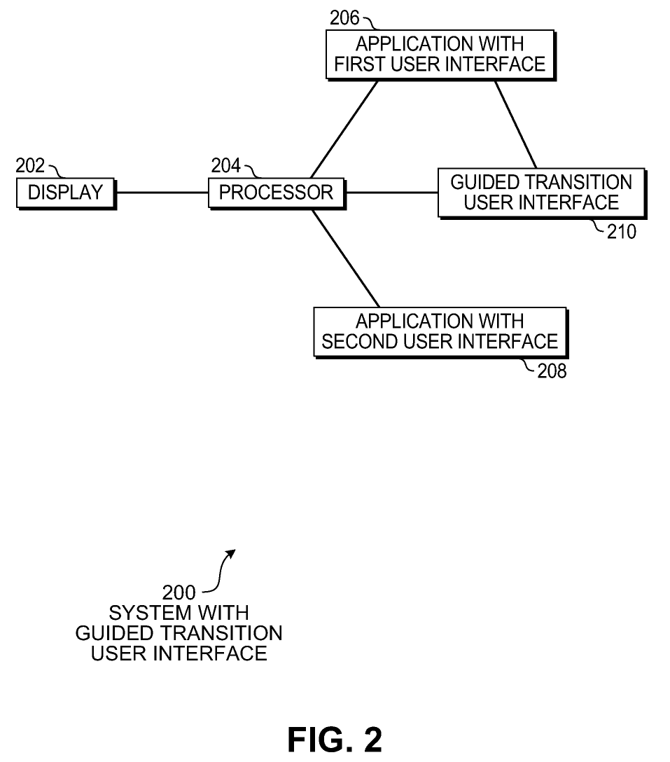

FIG. 2 is a diagram illustration of an embodiment 200 showing a system with a guided transition user interface. Embodiment 200 is an example of a system architecture that shows various hardware and software components.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various components described.

A display 202 may be controlled by a processor 204. Many examples of such devices exist, including personal computers, server computers, hand held devices such as personal digital assistants and mobile telephones, and other devices. In some cases, the device may be a general purpose device that is capable of loading and executing various applications such as a server computer, while in other cases the device may be a special purpose device such as a dedicated global positioning system (GPS) receiver, a handheld instrument, a network routing device, or other specialized device.

The processor 204 may operate application 206 with a first user interface and an application 208 with a second user interface. The first application 206 may have a guided transition user interface 210 that is displayed when the second application 208 is called.

The first application 206 may be any type of computer application that has a user interface that may be displayed on the display. The first user interface may be a graphical user interface that may include a link, button, or other mechanism that enables a user to transition to the second application 208. In many cases, the second application 208 may have a user interface that is not the same as the first application 206. In some cases, the second application 208 may have a user interface that is drastically different both in look and feel as well as detail of functionality.

The first application 206 may have a guided transition user interface 210 that is part of the first application 206 and may present a transitional user interface when the second application 208 is starting up. The transitional user interface may include graphical, textual, audio, or other elements that indicate a transition to the second application 208 and may provide guidance and help for a user for starting operations with the second application 208.

In some instances, the guided transition user interface 210 may include descriptions of multiple steps that a user may take to perform a specific task. Such descriptions may be presented in a temporal guided transition user interface 210 that is present for a short period of time and then disappears when control is passed to the second application 208. In other embodiments, the guided transition user interface 210 may be present at the same time as the second application 208 and may be used as a reference guide or help sequence while a user interacts with the second application 208.

The guided transition user interface 210 may be used to transition from a first user interface 206 that is being provided by a first computer device to a second user interface 208 that is being provided by a second computer device. The computer devices may be actual, physical devices or may be virtual devices such as virtual servers.

Such an embodiment may be useful when a user is in an environment where the user interacts with multiple computer devices. For example, many computing environments may use multiple virtual servers operating on a single hardware platform. As a user transitions from one user interface on one server, a guided transition user interface 210 may be shown that lets the user know that the next user interface will be provided from a second server. Such a transition user interface may be very helpful when a user switches back and forth between devices.

In some such embodiments, the guided transition user interface 210 may include various indicators for the second user interface 208. For example, a textual name or address for a host device for the second user interface 208 may be displayed, or an icon or other graphical representation of the host device. In some cases, a thumbnail image of the second user interface or host device may be included in the guided transition user interface 210.

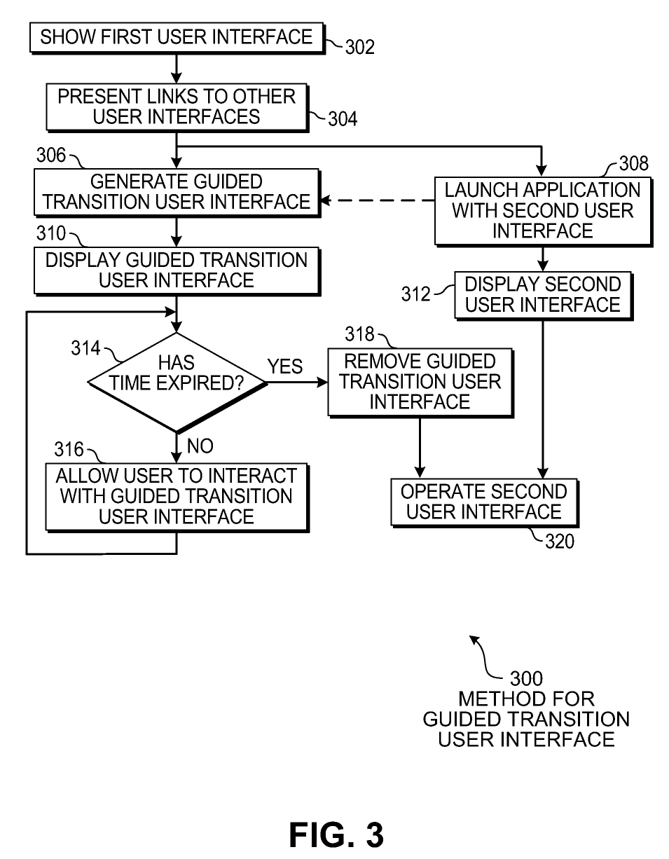

FIG. 3 is a flowchart illustration of an embodiment 300 showing a method for operating a guided transition user interface. Embodiment 300 illustrates one sequence or method for presenting a guided transition user interface when transitioning between two different user interfaces. Other embodiments may perform similar actions in similar or different sequences.

A first user interface may be shown in block 302. Within the first user interface, links to other user interfaces may be presented in block 304. In some cases, the other user interfaces may be user interfaces within the same application, while in other cases, the other user interfaces may be for different applications.

When the link is activated, a guided transition user interface is generated in block 306. In cases where the second user interface is provided by a second application, the second application may be launched in block 308.

In some embodiments, the guided transition user interface of block 306 may use one or more images from the second user interface of block 308. In such a case, an image within the guided transition user interface may be created dynamically or on the fly.

After generating the guided transition user interface in block 306, it is displayed in block 310. The second user interface may be displayed in block 312. In some cases, the second user interface may be viewable while the guided transition user interface is also viewable.

The guided transition user interface may be presented for a period of time and then removed. If the time has not expired in block 314, a user may be allowed to interact with the guided transition user interface in block 316. In some cases, when the user elects to interact with the guided transition user interface in block 316, the timer of block 314 may be suspended to enable a user to take as much time as the user may like to interact in block 316.

If the user does not interact and time has expired in block 314, the guided transition user interface may be removed in block 318 and the user may operate the second user interface in block 320.

Embodiment 300 is one method by which a guided transition user interface may be presented to bridge the gap between a first user interface and a second user interface. Embodiment 300 shows how a second application may be launched and the guided transition user interface may be used to display something while the second application is loading and preparing to display the second user interface.

In other embodiments, the guided transition user interface may be used in a similar manner as a set of help instructions and may be present while a user is operating the second user interface. In such cases, the guided transition user interface may not be removed as in block 318.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
presenting a first user interface, said user interface comprising a first link;
when said link is selected, transition to a second user interface by a method comprising:
launching said second user interface; and
presenting a guided transition user interface comprising a representation of said second user interface.

2. The method of claim 1, said first user interface being presented by a first application and said second user interface being presented by a second application.

3. The method of claim 2, said second user interface being a portion of said second application where a task described by said first link may be performed.

4. The method of claim 1, said first user interface being generated by a first computing device and said second user interface being generated by a second computing device, said first user interface and said second user interface being presented on a first display device.

5. The method of claim 4, said first computing device and said second computing device being a first physical device and a second physical device, respectively.

6. The method of claim 4, said first computing device and said second computing device being a first virtual device and a second virtual device, respectively.

7. The method of claim 1, said representation of said second user interface comprising at least one of a group composed of:
a box;
a circle;
a highlighted area;
a shaded area;
an area with altered color;
highlighted text; and
shaded text.

8. The method of claim 1, said guided transition user interface further comprising at least one of a group composed of:
a description of a task to perform, said description being at least one of a group composed of a textual description or a graphical description;
a description of a device providing said second user interface, said description being at least one of a group composed of iconic description, textual description, or graphical description;
a description of an application providing said second user interface, said description being at least one of a group composed of iconic description, textual description, or graphical description.

9. The method of claim 1, said guided transition user interface comprising at least one portion being dynamically configured.

10. The method of claim 9, said at least one portion comprising at least one of a group composed of text and graphical representation.

11. A computer readable medium comprising computer executable instructions adapted to perform the method of claim 1.

12. A system comprising:
a display device;
a first user interface comprising a link, said link being related to a first task;
a processor adapted to:
transition to a second user interface when said link is activated by presenting a guided transition user interface for a predetermined period of time and launching a second user interface, said guided transition user interface comprising a representation of a portion of said second user interface and a representation of said first task.

13. The system of claim 12, said guided transition user interface having a user interactive device, said user interactive device being capable of not displaying said guided transition user interface when said link is subsequently activated.

14. The system of claim 12, said first user interface being provided by a first computing device and said second user interface being provided by a second computing device, said guided transition user interface comprising an indication of said second computing device.

15. The system of claim 14, said second computing device being a remote service.

16. The system of claim 12 being adapted to manage a plurality of computer server functions.

17. A method of transitioning from a first user interface to a second user interface comprising:
presenting an interactive device on said first user interface defining at least a part of a first task to perform;
when said interactive device is operated, launching said second user interface;
presenting a guided transition user interface comprising a reference to said first task and a representation of said second user interface.

18. The method of claim 17, said first user interface being provided by a first application and said second user interface being provided by a second application.

19. The method of claim 17, said first user interface being provided by a first computing device and said second user interface being provided by a second computing device.

20. A computer readable medium comprising computer executable instructions adapted to perform the method of claim 17.
